(19) United States
(12) Patent Application Publication
(10) Pub. No.: US 2012/0167082 A1
(43) Pub. Date: Jun. 28, 2012

(54) DIRECT SHARING OF SMART DEVICES THROUGH VIRTUALIZATION

(76) Inventors: Sanjay Kumar, Hillsboro, OR (US); David J. Cowperthwaite, Hillsboro, OR (US); Philip R. Lantz, Cornelius, OR (US); Rajesh M. Sankaran, Protland, OR (US)

(21) Appl. No.: 12/977,490

(22) Filed: Dec. 23, 2010

(51) Int. Cl. G06F 9/455

(52) U.S. Cl. 718/1

(57) ABSTRACT

In some embodiments devices are enabled to run virtual machine workloads directly. Isolation and scheduling are provided between workloads from different virtual machines. Other embodiments are described and claimed.

### TECHNICAL FIELD

The inventions generally relate to direct sharing of smart devices through virtualization.

### BACKGROUND

Input/Output (I/O) device virtualization has previously been implemented using a device model to perform full device emulation. This allows sharing of the device, but has significant performance overhead. Direct device assignment of the device to a Virtual Machine (VM) allows close to native performance but does not allow the device to be shared among VMs. Recent hardware based designs such as Single Root I/O Virtualization (SR-IOV) allow the device to be shared while exhibiting close to native performance, but require significant changes to the hardware.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a system according to some embodiments of the inventions.

FIG. 2 illustrates a flow according to some embodiments of the inventions.

FIG. 3 illustrates a system according to some embodiments of the inventions.

FIG. 4 illustrates a system according to some embodiments of the inventions.

FIG. 5 illustrates a system according to some embodiments of the inventions.

### DETAILED DESCRIPTION

Some embodiments of the inventions relate to direct sharing of smart devices through virtualization.

In some embodiments devices are enabled to run virtual machine workloads directly.

Isolation and scheduling are provided between workloads from different virtual machines.

In some embodiments high performance Input/Output (I/O) device virtualization is accomplished while sharing the I/O device among multiple Virtual Machines (VMs). In some embodiments, a hybrid technique of device emulation and direct device assignments provide device model based direct execution. According to some embodiments, an alternative to Single Root I/O Virtualization (SR-IOV) based designs is provided in which very few changes are made to the hardware as compared with SR-IOV. According to some embodiments, the higher degree of programmability in modern devices (for example, modern devices such as General Purpose Graphics Processing Units or GPGPUs) is exploited, and close to native I/O performance is provided in VMs.

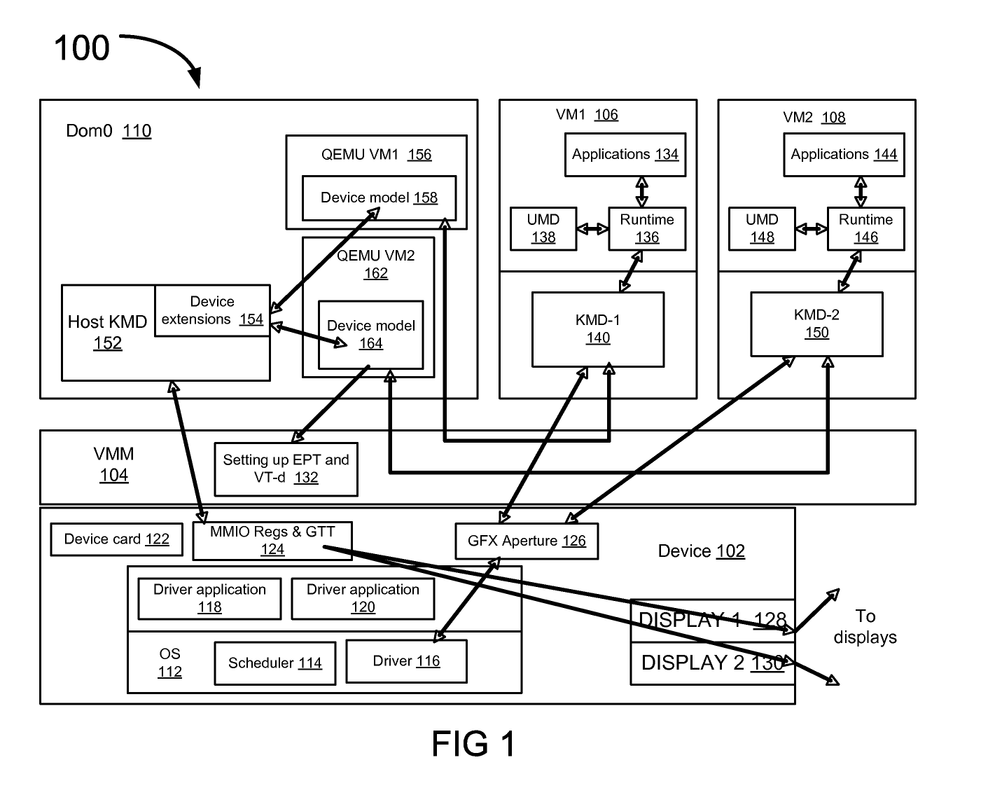

FIG. 1 illustrates a system 100 according to some embodiments. In some embodiments system 100 includes a device 102 and a Virtual Machine Monitor (VMM) 104. In some embodiments system 100 includes a Virtual Machine VM1 106, a Virtual Machine VM2 108, and a Dom0 (or domain zero) 110, which is the first domain started by the VMM 104 on boot, for example. In some embodiments, device 102 is an I/O device, a Graphics Processing Unit or GPU, and/or a General Purpose Graphics Processing Unit or GPGPU such as the Intel Larrabee Graphics Processing Unit, for example.

In some embodiments, device 102 includes an Operating System (OS) 112 (for example, a full FreeBSD based OS called micro-OS or uOS). In some embodiments OS 112 includes a scheduler 114 and a driver 116 (for example, a host driver). In some embodiments device 102 includes a driver application 118, a driver application 120, a device card 122, Memory-mapped Input/Output (MMIO) registers and GTT memory 124, a graphics aperture 126, a display interface 128, and a display interface 130. In some embodiments, VMM 104 is a Xen VMM and/or open source VMM. In some embodiments, VMM 104 includes capabilities of setting up EPT page tables and VT-d extensions at 132. In some embodiments, VM 106 includes applications 134 (for example, DX applications), runtime 136 (for example, DX runtime), device UMD 138, and kernel-mode driver (KMD) 140 (and/or emulated device). In some embodiments, VM 108 includes applications 144 (for example, DX applications), runtime 146 (for example, DX runtime), device UMD 148, and kernel-mode driver (KMD) 150 (and/or emulated device). In some embodiments domain zero (Dom0) 110 includes a host Kernel Mode Driver (KMD) 152 that includes virtual host extensions 154. In some embodiments, Dom0 110 includes a processor emulator QEMU VM1 156 operating as a hosted VMM and including device model 158. In some embodiments, Dom0 110 includes a processor emulator QEMU VM2 162 operating as a hosted VMM and including device model 164.

According to some embodiments, virtualization of I/O device 102 is performed in a manner that provides high performance and the ability to share the device 102 among VMs 106 and 108 without requiring significant hardware changes. This accomplished by modifying the hardware and the software/firmware of the device 102 so that the device 102 is aware of the VMM 104 and one or more VMs (such as, for example, VMs 106 and 108). This enables device 102 to interact directly with various VMs (106 and 108) in a manner that provides high performance. The device 102 is also responsible for providing isolation and scheduling among workloads from different VMs. However, in order to minimize changes to hardware of device 102, this technique also requires a traditional device emulation model in the VMM 104 which emulates the same device as the physical device 102. Low frequency accesses to device 102 from the VMs 106 and 108 (for example, accesses to do device setup) are trapped and emulated by the device model 164, but high frequency accesses (for example, sending/receiving data to/from the device, interrupts, etc.) go directly to the device 102, avoiding costly VMM 104 involvement.

In some embodiments, a device model in the VMM 104 presents a virtual device to the VM 106 or 108 that is the same as the actual physical device 102, and handles all the low frequency accesses to device resources. In some embodiments, this model also sets up direct VM access to the high frequency device resources. In some embodiments, a VMM component 104 is formed on the device 102 in a manner that makes the device 102 virtualization aware and enables it to talk to multiple VMs 106 and 108 directly. This component handles all the high frequency VM accesses and enables device sharing.

According to some embodiments, minimal changes are required to the hardware of device 102 as compared with a Single Root I/O Virtualization (SR-IOV) design. A software component running on device 102 is modified to include the VMM 104 component, and through this VMM component offloads the VMM handling of high frequency VM access to the device itself.

According to some embodiments, the device 102 is a very smart device and is highly programmable (for example, a GPU such as Intel's Larrabee GPU in some embodiments). According to some embodiments, device 102 runs a full FreeBSD based OS 112 referred to as micro-OS or uOS. In some embodiments, a device card is shared between two VMs 106 and 108, which are Windows Vista VMs according to some embodiments. The VMs 106 and 108 submit work directly to the device 102, resulting in close to native performance.

In some embodiments, VMM 104 is implemented using Xen (an open source VMM). In some embodiments, a virtualized device model is written using Xen to provide an emulated device to each VM 106 and 108. This model also provides the VMs 106 and 108 direct access to the graphics aperture 126 of the device 102, enabling the VM 106 and/or 108 to submit work directly to the device 102. A device extension to the host driver is also used to enable the device model 164 to control some aspects of device operation. For the VMM component on the device 102, the driver 116 is modified according to some embodiments to make it virtualization aware and enable it to receive work directly from multiple VMs. A graphics application in a VM 106 or 108 starts an OS 112 application on the device 102 side. Then the VM application 134 or 144 sends workload data to the corresponding device application 118 or 120 for processing (for example, rendering). The modified driver 116 enables the OS 112 to run applications 118 and 120 from multiple VMs 106 and 108 just as if they were multiple applications from the same host. Running workloads from different VMs in distinct OS applications provides isolation between them. In some embodiments, the OS scheduler 114 is also modified to enable it to schedule applications from different VMs so that applications from one VM do not starve those from another VM.

In some embodiments, graphics device virtualization is implemented in the VMM 104. In some embodiments, the two VMs 106 and 108 share a single device card and run their workload directly on the device 102 through a direct access via graphics aperture 126. The OS 112 driver 116 and scheduler 114 are modified according to some embodiments to provide isolation and scheduling from multiple Vms (for example, between applications 134 and 144 and/or between DX applications).

According to some embodiments, five major techniques may be implemented to perform I/O device virtualization, as follows.

1. Full device emulation—In full device emulation the VMM uses a device model to emulate a hardware device. The VM sees the emulated device and tries to access it. These accesses are trapped and handled by the device model. Some of these accesses require access to the physical device in the VMM to service requests of the VMs. The virtual device emulated by the model can be independent of the physical device present in the system. This is a big advantage of this technique, and it makes VM migration simpler. However, a disadvantage of this technique is that emulating a device has high performance overhead, so this technique does not provide close to native performance in a VM.

2. Direct device assignment—In this technique, the device is directly assigned to a VM and all the device's Memory-mapped I/O (MMIO) resources are accessible directly by the VM. This achieves native I/O performance in a VM. However, a disadvantage is that the device cannot be shared by other VMs. Additionally, VM migration becomes much more complex.

3. Para-virtualized drivers in VMs—In this approach, para-virtualized drivers are loaded inside VMs which talk to a VMM driver to enable sharing. In this technique, the virtual device can be independent of the physical device and can achieve better performance than a device model based approach. However, a disadvantage of this approach is that it requires new drivers inside the VMs, and the performance is still not close to what is achieved by device assignment. Additionally, the translation between virtual device semantics and physical device semantics are complex to implement and often not feature complete (for example, API proxying in graphics virtualization).

4. Mediated Pass-Through (MPT) or Assisted Driver Pass-Through (ADPT)—VMM vendors have recently proposed an improved technique over para-virtualized drivers called MPT or ADPT where the emulated virtual device is the same as the physical device. This enables the VM to use the existing device drivers (with some modifications to allow it to talk to the VMM). This also avoids the overheads of translating the VM workload from virtual device format to physical device format (since both devices are the same). The disadvantage of this approach is that the performance is still not close to what is achieved by device assignment because VMs still cannot directly communicate with the device.

5. Hardware approaches (for example, SR-IOV)—In this approach, the device hardware is modified to create multiple instances of the device resources, one for each VM. Single Root I/O Virtualization (SR-IOV) is a standard that is popular among hardware vendors and specifies the software interface for such devices. It creates multiple instances of device resources (a physical function or PF) and multiple virtual functions or VF). The advantage of this approach is that now the device can be shared between multiple VMs and can give high performance at the same time. The disadvantage is that it requires significant hardware changes to the device. Another disadvantage is that the device resources are statically created to support a specified number of VMs (e.g., if the device is built to support four VMs and currently only two VMs are running, the other two VMs' worth of resources are unused and are not available to the two running VMs).

According to some embodiments, a hybrid approach of techniques 4 and 5 above is used to achieve a high performance shareable device. However, this hybrid approach does not require most of the hardware changes required by technique 5. Also, the device resources are allowed to be dynamically allocated to VMs (instead of statically partitioned as in technique 5). Since the hardware and software running on the device are modified in some embodiments, it can directly communicate with the VMs, resulting in close to native performance (unlike technique 4). Similar to technique 4, in some embodiments a device model is used which emulates the same virtual device as the physical device. The device model along with changes in the device software/firmware obviates most of the hardware changes required by technique 5. Similar to technique 2, in some embodiments some of the device resources are mapped directly into the VMs so that the VMs can directly talk to the device. However, unlike technique 2, in some embodiments the device resources are mapped in a way that keeps the device shareable among multiple VMs. Similar to technique 5, the device behavior is modified to achieve high performance in some embodiments. However, unlike technique 5, the device software/firmware is primarily modified, and only minimal changes to hardware are made, thus keeping the device cost low and reducing time to market. Also, by making changes in device software (instead of hardware) dynamic allocation of device resources to VMs is made on an on-demand basis.

According to some embodiments, high performance I/O virtualization is implemented, with device sharing capability and the ability to dynamically allocate device resources to VMs, without requiring significant hardware changes to the device. None of the current solutions provide all four of these features. In some embodiments, changes are made to device software/firmware, and some changes are made to hardware to enable devices to run VM workloads directly and to provide isolation and scheduling between workloads from different VMs.

In some embodiments a hybrid approach using model based direct execution is implemented. In some embodiments the device software/firmware is modified instead of creating multiple instances of device hardware resources. This enables isolation and scheduling among workloads from different VMs.

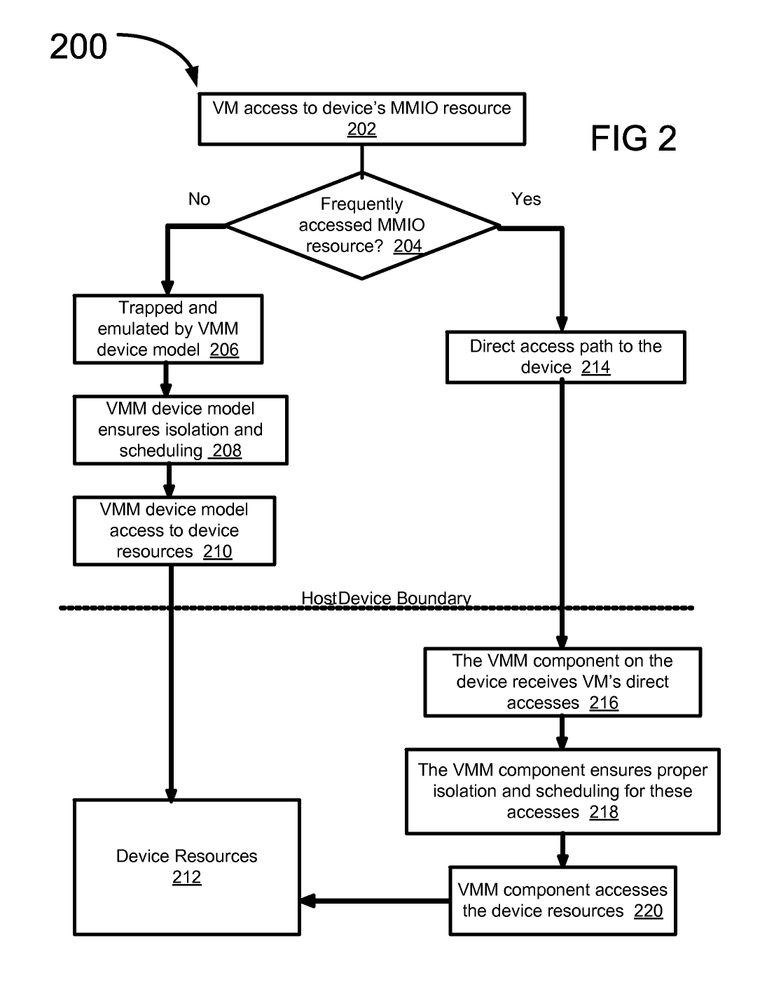

FIG. 2 illustrates a flow 200 according to some embodiments. In some embodiments, a VM requests access to a device's resource (for example, the device's MMIO resource) at 202. A determination is made at 204 as to whether the MMIO resource is a frequently accessed resource. If it is not a frequently accessed resource at 204, the request is trapped and emulated by a VMM device model at 206. Then the VMM device model ensures isolation and scheduling at 208. At 210 the VMM device model accesses device resources 212. If it is a frequently accessed resource at 204, a direct access path to the device is used by the VM at 214. The VMM component on the device receives the VM's direct accesses at 216. Then the VMM component ensures proper isolation and scheduling for these accesses at 218. At 220, the VMM component accesses the device resources 212.

Modern devices are becoming increasingly programmable, and a significant part of device functionality is implemented in software/firmware running on the device. In some embodiments, minimal or no change to device hardware is necessary. According to some embodiments, therefore, changes to a device such as an I/O device is much faster (as compared with a hardware approach using SR-IOV, for example). In some embodiments, devices such as I/O devices can be virtualized in very little time. Device software/firmware may be changed according to some embodiments to provide high performance I/O virtualization.

In some embodiments multiple requester IDs may be emulated using a single I/O Memory Management Unit (IOMMU) table.

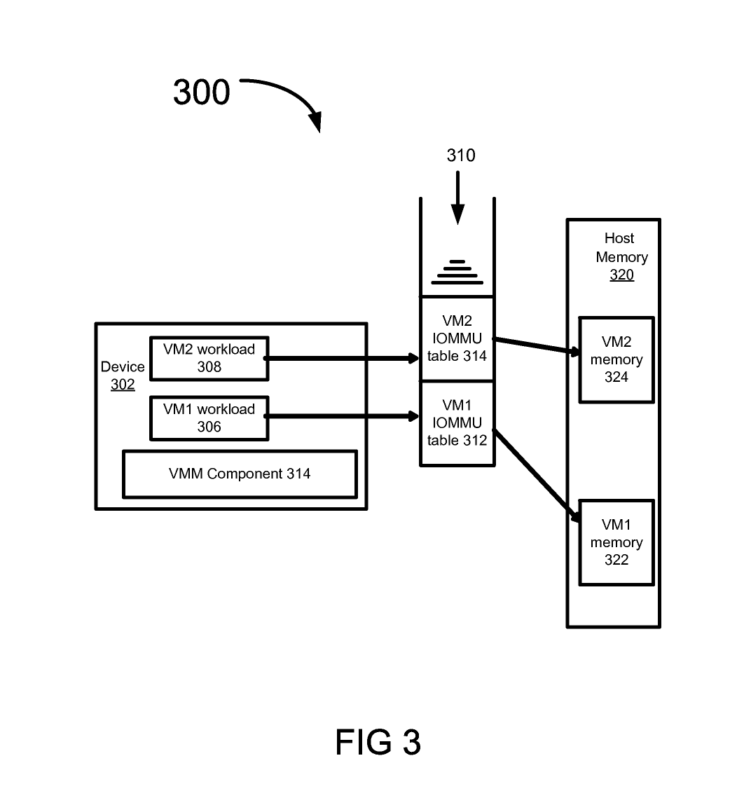

FIG. 3 illustrates a system 300 according to some embodiments. In some embodiments, system 300 includes a device 302 (for example, an I/O device). Device 302 has a VMM component on the device as well as a first VM workload 306 and a second VM workload 308. System 300 additionally includes a merged IOMMU table 310 that includes a first VM IOMMU table 312 and a second VM IOMMU table 314. System 300 further includes a host memory 320 that includes a first VM memory 322 and a second VM memory 324.

The VMM component 304 on the device 302 tags the guest physical addresses (GPAs) before workloads use them. The workload 306 uses a GPA1 tagged with the IOMMU table id to access VM1 IOMMU table 312 and workload 308 uses a GPA2 tagged with the IOMMU table id to access VM2 IOMMU table 312.

FIG. 3 relates to the problem of sharing a single device 302 (for example, an I/O device) among multiple VMs when each of the VMs can access the device directly for high performance I/O. Since the VM is accessing the device directly, it provides the device with a guest physical address (GPA). The device 302 accesses the VM memory 322 and/or 324 by using an IOMMU table 310 which converts the VM's GPA into a Host Physical Address (HPA) before using the address to access memory. Currently, each device function can use a single IOMMU table by using an identifier called requester ID (every device function has a requester ID). However, a different IOMMU table is required for each VM to provide individual GPA to HPA mapping for the VM. Therefore, a function cannot be shared directly among multiple VMs because the device function can access only one IOMMU table at a time.

System 300 of FIG. 3 solves the above problem by emulating multiple requester IDs for a single device function so that it can have access to multiple IOMMU tables simultaneously. Having access to multiple IOMMU tables enables the device function to access multiple VMs' memory simultaneously and be shared by these VMs.

Multiple IOMMU tables 312 and 314 are merged into a single IOMMU table 310, and the device function uses this merged IOMMU table. The IOMMU tables 312 and 314 are merged by placing the mapping of each table at a different offset in the merged IOMMU table 310, so that the higher order bits of the GPA represent IOMMU table ID. For example, if we assume that the individual IOMMU tables 312 and 314 map 39 bit addresses (which can map 512 GB of guest memory) and the merged IOMMU table 310 can map 48 bit addresses, a merged IOMMU table may be created and mappings of the first IOMMU table is provided at offset 0, the second IOMMU table at offset 512 GB, a third IOMMU table at offset 1 TB, and so on. Effectively high order bits 39-47 become an identifier for the individual IOMMU table number in the merged IOMMU table 310.

To work with this merged table, the GPAs intended for different IOMMU tables are modified. For example, the second IOMMU table's GPA 0 appears at GPA 512 GB in the merged IOMMU table. This requires changing the addresses (GPAs) being used by the device to reflect this change in the IOMMU GPA so that they use the correct part of merged IOMMU table. Essentially the higher order bits of the GPAs are tagged with IOMMU table number before the device accesses those GPAs. In some embodiments, the software/firmware running on the device is modified to perform this tagging.

System 300 includes two important components according to some embodiments. VMM component 304 creates the merged IOMMU table 310 and lets the device function use this IOMMU table. Additionally, a device component which receives GPAs from the VMs and tags them with the IOMMU table number corresponding to the VM that the GPA was received from. This allows the device to correctly use the mapping of that VM's IOMMU table (which is now part of the merged IOMMU table). The tagging of GPAs by the device and creation of a merged IOMMU table collectively emulates multiple requestor IDs using a single requestor ID.

System 300 includes two VMs and their corresponding IOMMU tables. These IOMMU tables have been combined into a single Merged IOMMU table at different offsets and these offsets have been tagged into the GPAs used by the corresponding VM's workload on the device. This essentially emulates multiple RIDs using a single IOMMU table. Although FIG. 3 represents the VMs' memory as contiguous blocks in Host Memory, the VMs' memory can actually be in non-contiguous pages scattered throughout Host Memory. The IOMMU table maps from a contiguous range of GPAs for each VM to the non-contiguous physical pages in Host Memory.

According to some embodiments, device 302 is a GPU. In some embodiments, device 302 is an Intel Larrabee GPU. As discussed herein, a GPU such as the Larrabee GPU is a very smart device and is highly programmable. In some embodiments it runs a full FreeBSD based OS called Micro-OS or uOS as discussed herein. This makes it an ideal candidate for this technique. In some embodiments, a single device card (for example, single Larrabee card) is shared by two Windows Vista VMs. The VMs submit work directly to the device, resulting in close to native performance. In some embodiments an open source VMM such as a Xen VMM is used. In some embodiments, the VMM (and/or Xen VMM) is modified to create the merged IOMMU table 310. In some embodiment, the device OS driver is modified so that when it sets up page tables for device applications it tags the GPAs with the IOMMU table number used by the VM. It also tags the GPAs when it needs to do DMA between host memory and local memory. This causes all accesses to GPAs to be mapped to the correct HPAs using the merged IOMMU table.

Current devices (e.g., SR-IOV devices) implement multiple device functions in the device to create multiple requester IDs (RID). Having multiple RIDs enables the device to use multiple IOMMU tables simultaneously. This requires significant changes to device hardware which increases the cost of the device and the time to market, however.

In some embodiments, address translation is performed in the VMM device model. When the VM attempts to submit work buffer to the device, it generates a trap into VMM, which parses the VM's work buffer to find the GPA and then translates the GPA into HPA before the work buffer is given to the device. Because of frequent VMM traps and parsing of work buffer, this technique has very high virtualization overhead.

In some embodiments, only minor modifications to device software/firmware are necessary (instead of creating separate device functions) to enable it use multiple IOMMU tables using a single requester ID. The VMM 304 creates a merged IOMMU table 310 which includes the IOMMU tables of all the VMs sharing the device 302. The device tags each GPA with corresponding IOMMU table number before accessing the GPA. This reduces the device cost and time to market.

Current solutions do not utilize programmability in modern I/O devices (e.g., Intel's Larrabee GPU) to enable it to access multiple IOMMU tables simultaneously. Instead they depend on hardware changes to implement multiple device functions to enable it to access multiple IOMMU tables simultaneously.

In some embodiments a merged IOMMU table is used (which includes mapping from multiple individual IOMMU tables) and the device software/firmware is modified to tag GPAs with the individual IOMMU table number.

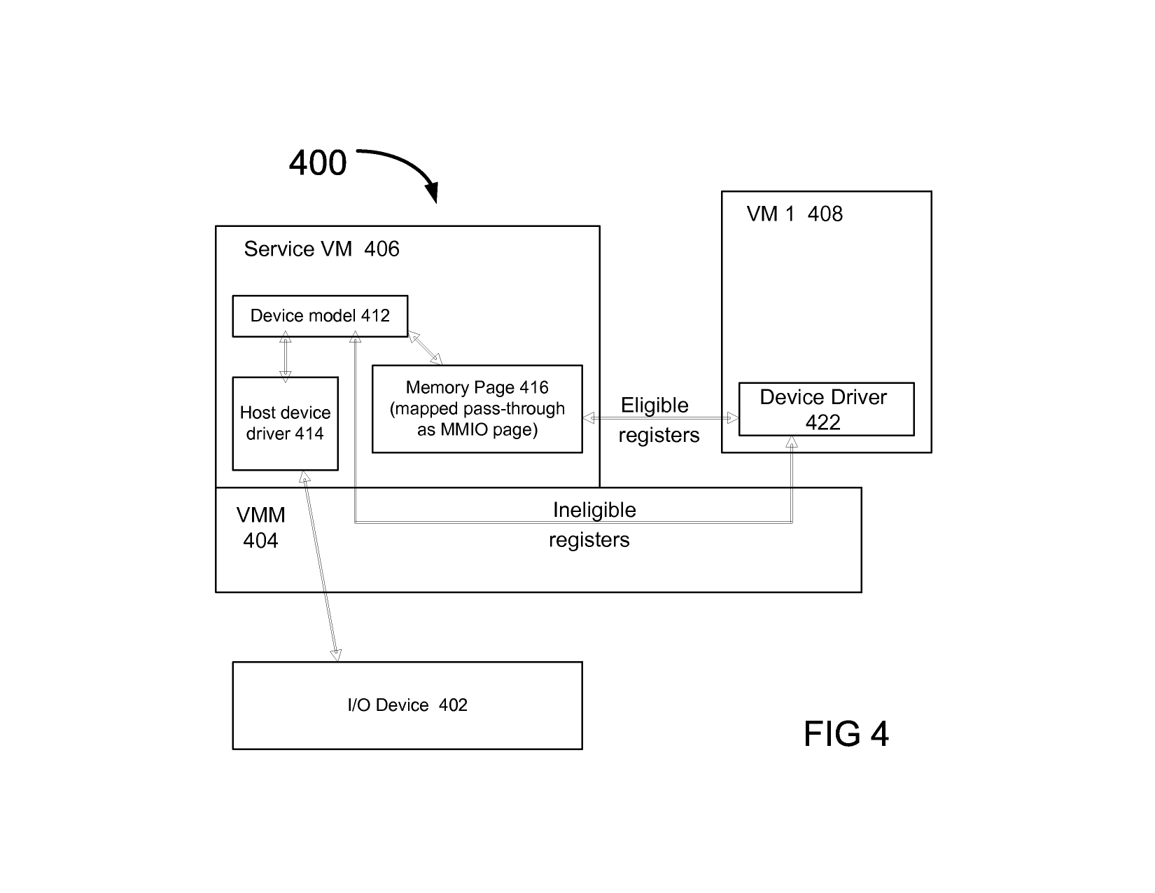

FIG. 4 illustrates a system 400 according to some embodiments. In some embodiments, system 400 includes a device 402 (for example, an I/O device), VMM 404, Service VM 406, and VM1 408. Service VM 406 includes a device model 412, a host device driver 414, and a memory page 416 (with mapped pass-through as MMIO page). VM1 408 includes a device driver 422.

FIG. 4 illustrates using memory backed registers (for example, MMIO registers) to reduce VMM traps in device virtualization. A VMM 404 runs VM1 408 and virtualizes an I/O device 402 using a device model 412 according to some embodiments. The device model 412 allocates a memory page and maps the MMIO page of the VM's I/O device pass-through onto this memory page. The device's eligible registers reside on this page. The device model 412 and VM's device driver 422 can both directly access the eligible registers by accessing this page. The accesses to ineligible registers are still trapped by the VMM 404 and emulated by the device model 412.

I/O device virtualization using full device emulation requires a software device model in the VMM that emulates a hardware device for the VM. The emulated hardware device is often based on existing physical devices in order to leverage the device drivers present in commercial operating systems. The VM 408 sees the hardware device emulated by the VMM device model 412 and accesses it through reads and writes to its PCI, I/O and MMIO (memory-mapped I/O) spaces as it would a physical device. These accesses are trapped by the VMM 404 and forwarded to the device model 412 where they are properly emulated. Most modern I/O devices expose their registers through memory mapped I/O in ranges that are configured by the device's PCI MMIO BARs (Base Address Registers). However, trapping every VM access to the device's MMIO registers may have significant overhead and greatly reduce the performance of a virtualized device. Some of the emulated device's MMIO registers, on read/write by a VM, do not require any extra processing by device model except returning/writing the value of the register. The VMM 404 doesn't necessarily need to trap access to such registers (henceforth referred to as eligible registers) as there is no processing to be performed as a result of the access. However, current VMMs do trap on accesses to eligible registers unnecessarily increasing virtualization overhead in doing device virtualization. This overhead becomes much more significant if the eligible register is frequently accessed by the VM 408.

System 400 reduces the number of VMM traps caused by accesses to MMIO registers by backing eligible registers with memory. The device model 412 in the VMM allocates memory pages for eligible registers and maps these pages into the VM as RO (for read-only eligible registers) or RW (for read/write eligible registers). When the VM 408 makes an eligible access to an eligible register, the access is made to the memory without trapping to the VMM 404. The device model 412 uses the memory pages as the location of virtual registers in the device's MMIO space. The device model 412 emulates these registers asynchronously, by populating the memory with appropriate values and/or reading the values the VM 408 has written. By reducing the number of VMM traps, device virtualization performance is improved.

Eligible registers are mapped pass-through (either read-only or read-write depending on the register semantics) into the VM's address space using normal memory virtualization techniques (shadow page tables or Extended Page Tables (EPT)). However, since MMIO addresses can be mapped into VMs only at page size granularity, mapping these registers pass-through will map every other register on that page pass-through into the VM 408 as well. Hence, the VMM 404 can map eligible device registers pass-through into the VM 408 only if no ineligible registers reside on the same page. Hence, the MMIO register layout of devices is designed according to some embodiments such that no ineligible register resides on the same page as an eligible register. The eligible registers are further classified as read-only and read/write pass-through registers and these two types of eligible registers need to be on separate MMIO pages. If the VM is using paravirtualized drivers, it can create such a virtualization friendly MMIO layout for the device so that there is no need to depend on hardware devices with such MMIO layout

Current VMMs do not map eligible device registers pass-through into VMs and incur unnecessary virtualization overhead by trapping on accesses to these registers. One of the reasons could be that the eligible registers are located on the same MMIO pages as ineligible registers. Current VMMs use paravirtualized drivers in VMs to reduce VMM traps. These paravirtualized drivers avoid making unnecessary register accesses (e.g., because value of those registers is meaningless in a VM) or batch those register accesses (e.g., to write a series of registers to program a device).

System 400 uses new techniques to further reduce the number of VMM traps in I/O device virtualization resulting in significantly better device virtualization performance. System 400 uses memory backed eligible registers for the VM's device and maps those memory pages into the VM to reduce the number of VMM traps in accessing the virtual device.

Current VMM device models do not map the eligible device registers pass-through into the VMs and incur unnecessary virtualization overhead by trapping on their access. This results in more VMM traps in virtualizing the device than is necessary.

According to some embodiments, eligible MMIO registers are backed with memory and the memory pages are mapped to pass-through in the VM to reduce VM traps.

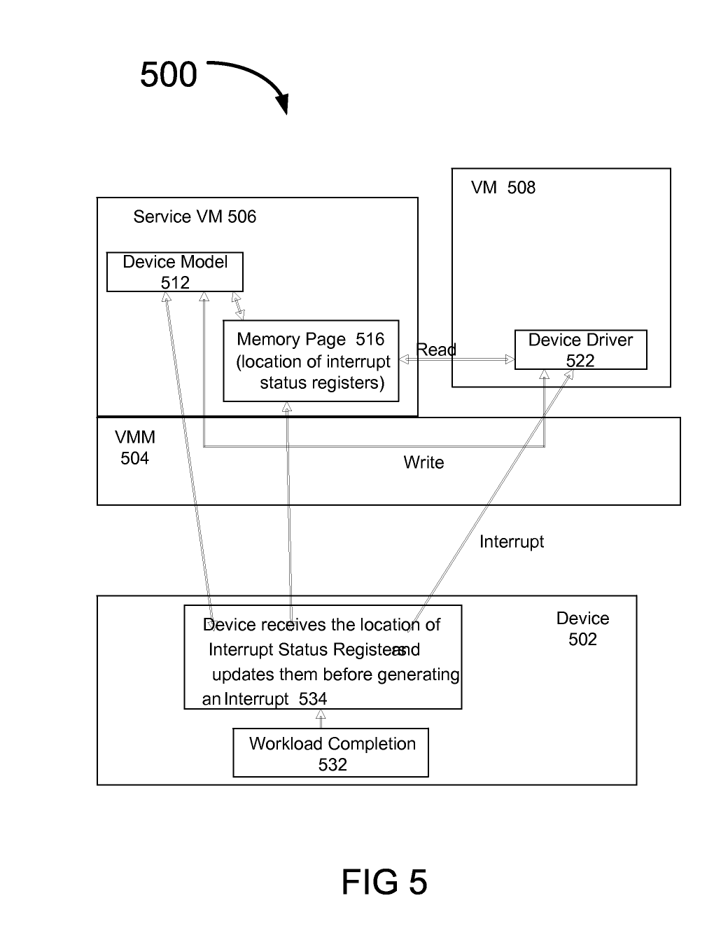

FIG. 5 illustrates a system 500 according to some embodiments. In some embodiments, system 500 includes a device 502 (for example, an I/O device), VMM 504, Service VM 506, and a VM 508. Service VM 506 includes a device model 512, a host device driver 514, and a memory page 516 which includes interrupt status registers. VM 508 includes a device driver 522. In the device 502, upon workload completion 532, the device 502 receives the location of Interrupt Status Registers (for example, the interrupt status registers in memory page 516) and updates them before generating an interrupt at 534.

System 500 illustrates directly injecting interrupts into a VM 508. The VMM 504 runs the VM 508 virtualizes its I/O device 502 using a device model 512. The device model allocates a memory page 516 to contain the interrupt status registers and communicates its address to the physical I/O device. The device model 512 also maps the memory page read-only pass-through into the VM 508. The I/O device 502, after completing a VM's workload, updates the interrupt status registers on the memory page 516 and then generates an interrupt. On receipt of the device interrupt, the processor directly injects the interrupt into the VM 508. This causes the VM's device driver 522 to read the interrupt status registers (without generating any VMM trap). When the device driver 522 writes to these registers (to acknowledge the interrupt), it generates a VMM trap and the device model 512 handles it.

As discussed herein, VMMs provide I/O device virtualization to enable VMs to use physical I/O devices. Many VMMs use device models to allow multiple VMs to use a single physical device. I/O virtualization overhead is the biggest fraction of total virtualization overhead. A big fraction of I/O virtualization overhead is the overhead involved in handling a device interrupt for the VM. When the physical device is done processing a request from the VM, it generates an interrupt which is trapped and handled by the VMM's device model. The device model sets up the virtual interrupt status registers and injects the interrupt into the VM. It has been observed that injecting the interrupt into a VM is a very heavyweight operation. It requires scheduling the VM and sending an IPI to the processor chosen to run the VM. This contributes significantly to virtualization overhead. The VM, upon receiving the interrupt, reads the interrupt status register. This generates another trap to the VMM's device model, which returns the value of the register.

To reduce the interrupt handling latency, hardware features (named virtual interrupt delivery and posted interrupts) may be used for direct interrupt injection into the VM without VMM involvement. These hardware features allow a device to directly interrupt a VM. While these technologies work for direct device assignment and SR-IOV devices, the direct interrupt injection doesn't work for device model based virtualization solutions. This is because the interrupt status for the VM's device is managed by the device model and the device model must be notified of the interrupt so that it can update the interrupt status.

System 500 enables direct interrupt injection into VMs for device-model-based virtualization solutions. Since the VMM's device model doesn't get notified during direct interrupt injection, the device itself updates the interrupt status registers of the device model before generating the interrupt. The device model allocates memory for the interrupt status of the VM's device and communicates the location of this memory to the device. The device is modified (either in hardware or software/firmware running on the device) so that it receives the location of interrupt status registers from the device model and updates these locations appropriately before generating an interrupt. The device model also maps the interrupt status registers into the VM address space so that the VM's device driver can access them without generating a VMM trap. Often the interrupt status registers of devices have write 1 to clear (W1C) semantics (writing 1 to a bit of the register clears the bit). Such registers cannot be mapped read-write into the VM because RAM memory can't emulate WIC semantics. These interrupt status registers can be mapped read-only into the VM so that the VM can read the interrupt status register without any VMM trap and when it writes the interrupt status register (e.g., to acknowledge the interrupt), the VMM traps the access and the device model emulates the W1C semantics. Hence, some embodiments of system 500 use two important components.

A first important component of system 500 according to some embodiments is a VMM device model 512 which allocates memory for interrupt status registers, notifies the device about the location of these registers and maps this memory into the MMIO space of the VM 508.

A second important component of system 500 according to some embodiments is a device resident component 532 which receives the location of interrupt status registers from the device model 512 and updates them properly before generating an interrupt for the VM 508.

According to some embodiments, hardware is used that provides support for direct interrupt injection (for example, APIC features named virtual interrupt delivery and posted interrupts for Intel processors).

According to some embodiments, the VMM device model 512 offloads the responsibility of updating interrupt status registers to the device itself so that it doesn't need to be involved during interrupt injection into the VM. In current solutions, on a device interrupt, the device model updates the interrupt status registers and injects the interrupt into the VM. In system 500 of FIG. 5, the device updates the VM's interrupt status registers (the memory for these registers having been allocated by the device model beforehand) and generates the interrupt which gets directly injected into the VM. Additionally, the device model 512 also maps the interrupt status registers into the VM to avoid VMM traps when VM's device driver accesses these registers.

In current solutions, the interrupt status registers reside in the device itself. The device is not responsible for updating interrupt status registers in memory. Current device models also do not map these registers into the VM to avoid VMM traps when the VM's device driver accesses these registers.

According to some embodiments, a physical I/O device updates interrupt status registers of the device model in memory, allowing interrupts to be directly injected into VMs.

Although some embodiments have been described herein as being implemented in a particular manner, according to some embodiments these particular implementations may not be required.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A method comprising:
enabling devices to run virtual machine workloads directly; and
providing isolation and scheduling between workloads from different virtual machines.

2. The method of claim 1, further comprising modifying device software and/or firmware to enable isolation and scheduling of workloads from different virtual machines.

3. The method of claim 1, further comprising providing high performance Input/Output virtualization.

4. The method of claim 1, further comprising enabling device sharing by a plurality of virtual machines.

5. The method of claim 1, further comprising dynamically allocating device resources to virtual machines.

6. The method of claim 1, further comprising dynamically allocating device resources to virtual machines without requiring significant hardware changes to a device being virtualized.

7. The method of claim 1, further comprising directly accessing a path to a device being virtualized for a frequently accessed device resource.

8. The method of claim 1, further comprising ensuring isolation and scheduling for a non-frequently accessed device resource.

9. The method of claim 1, further comprising trapping and emulating.

10. The method of claim 1, further comprising accessing device resources using a virtual machine device model for a non-frequently accessed device resource.

11. An apparatus comprising:
a virtual machine monitor adapted to enable devices to run virtual machine workloads directly, and adapted to provide isolation and scheduling between workloads from different virtual machines.

12. The apparatus of claim 11, the virtual machine monitor adapted to modify device software and/or firmware to enable isolation and scheduling of workloads from different virtual machines.

13. The apparatus of claim 11, the virtual machine monitor adapted to provide high performance Input/Output virtualization.

14. The apparatus of claim 11, the virtual machine monitor adapted to enable device sharing by a plurality of virtual machines.

15. The apparatus of claim 11, the virtual machine monitor adapted to dynamically allocate device resources to virtual machines.

16. The apparatus of claim 11, the virtual machine monitor adapted to dynamically allocate device resources to virtual machines without requiring significant hardware changes to a device being virtualized.

17. The apparatus of claim 11, the virtual machine monitor adapted to directly access a path to a device being virtualized for a frequently accessed device resource.

18. The apparatus of claim 11, the virtual machine monitor adapted to ensure isolation and scheduling for a non-frequently accessed device resource.

19. The apparatus of claim 11, the virtual machine monitor adapted to trap and emulate.

20. The apparatus of claim 11, the virtual machine monitor adapted to access device resources using a virtual machine device model for a non-frequently accessed device resource.
